(19) United States
(12) Patent Application Publication
(10) Pub. No.: US 2022/0247159 A1
(43) Pub. Date: Aug. 4, 2022

(54) SWITCH ASSEMBLY FOR MOUNTING ON A MOUNTING RAIL

(71) Applicant: Ellenberger & Poensgen GmbH, Altdorf (DE)

(72) Inventors: Erich FISCHER, Altdorf (DE); Tobias PREM, Lauterhofen (DE); Herbert ROTH, Altdorf (DE)

(73) Assignee: Ellenberger & Poensgen GmbH, Altdorf (DE)

(21) Appl. No.: 17/726,281

(22) Filed: Apr. 21, 2022

Related U.S. Application Data
(63) Continuation of application No. PCT/EP2020/076425, filed on Sep. 22, 2020.

(30) Foreign Application Priority Data
Oct. 21, 2019 (DE) 10 2019 216 197.9

(51) Int. Cl. H02B 1/04; H02B 13/00

(52) U.S. Cl. CPC H02B 1/04; H02B 13/00

(57) ABSTRACT

A switch assembly for mounting on a mounting rail, having a power supply unit and having a switchgear. The power supply unit has a housing and a power supply, arranged therein, which comprises a first connection and a second connection. A contact region having a first contact, which is in electrical contact with the first connection, and having a second contact, which is in electrical contact with the second connection, is introduced into the housing. The housing has a fastening apparatus for direct placement on the mounting rail, and the switchgear comprises an additional housing having an additional fastening apparatus for direct placement on the mounting rail. The switchgear has a lever which is pivotably mounted on the additional housing and which has a first counterpart contact and a second counterpart contact.

This nonprovisional application is a continuation of International Application No. PCT/EP2020/076425, which was filed on Sep. 22, 2020, and which claims priority to German Patent Application No. 10 2019 216 197.9, which was filed in Germany on Oct. 21, 2019, and which are both herein incorporated by reference.

### BACKGROUND OF THE INVENTION

### Field of the Invention

The invention relates to a switch assembly for mounting on a mounting rail, such as a top-hat rail. The switch assembly has a power supply unit and a switchgear. Further, the invention relates to a power supply unit.

### Description of the Background Art

Switch assemblies are usually used for the central power supply of loads and consumers, thus acting as power distributors. The switch assembly is usually mounted on a mounting rail, such as a top-hat rail, in a switchgear cabinet. A power supply unit of the switch assembly is connected to a main power line, and a plurality of secondary circuits branch off from it. Usually, each of these secondary circuits is protected by means of a suitable protective device, such as a circuit breaker. By actuating the circuit breakers, it is thus possible to shut down the associated secondary circuit or at least to prevent it from being energized.

In order to simplify the mounting of the circuit breakers, the power distribution system usually comprises a number of connection modules into which the respective circuit breaker can be plugged or integrated. The connection modules are mechanically and electrically interconnected during production, so that the same number of connection modules is always present, regardless of how many secondary circuits actually exist. In order to increase flexibility, the individual components of the switch assembly are designed as devices mountable side-by-side and mounted individually on the mounting rail, directly or via an additional base system. For electrical contacting, it is necessary here to connect the devices electrically with one another by means of suitable cables, for which these must be connected to corresponding terminals of the devices. During assembly, it is imperative here that none of the connections and/or cables are interchanged, which makes mounting difficult.

Switching devices are known from DE 10 2015 218 108 B4, which corresponds to US 2018/0211804, which is incorporated herein by reference, and from DE 20 2015 009 391 U1, in which the electrical and mechanical connection to one another is made by means of a suitable lever, which is pivotably mounted on the housing of each switching device.

### SUMMARY OF THE INVENTION

It is therefore an object of the present invention to provide a particularly suitable switch assembly and a particularly suitable power supply unit, wherein advantageously mounting is simplified and/or a space requirement is reduced.

The exemplary switch assembly is, for example, a component of an industrial installation, a domestic supply, a boat, or any other motor vehicle, in particular one that is land-based. The switch assembly is at least suitable to be operated there in each case. The switch assembly is preferably used for power distribution and/or supplying. Suitably, the switch assembly is useful for connection to a main line. The switch assembly is suitable and intended to be attached, in particular fastened, to a mounting rail. The mounting rail is, for example, a top-hat rail or G-rail.

The switch assembly has a power supply unit, which is preferably provided for connection to any main line. The power supply unit comprises a housing which is made, for example, at least partially from a metal, sheet metal, or a plastic. For example, one side of the housing has a ventilation grille so that it is possible to exchange air from inside the housing to an environment. It is thus possible to dissipate heat from the housing. A power supply or another power supply unit, which is, for example, a switched-mode power supply, is arranged within the housing. Alternatively, the power supply is, for example, a converter, transformer, or other device by means of which electrical voltage is provided, wherein the electrical voltage is expediently regulated and/or set to a specific value. In particular, the power supply is a regulated power supply.

For example, an electrical alternating voltage or, particularly preferably, an electrical direct voltage is provided by means of the power supply. The power supply has a first and second connection for this purpose, wherein during operation the electrical voltage provided by the power supply is present between the two connections. This is, for example, an alternating voltage, which in particular has a frequency of 50 Hz or 60 Hz. Alternatively, this is expediently a direct voltage, wherein, for example, an electrical voltage of 12 V or 24 V or 48 V is present between the two connections. Suitably, one of the connections is electrically connected to ground, in particular to earth. Preferably, the power supply unit has a connector and/or terminals to which any main power line is connectable. The connector/terminals are preferably incorporated into the housing so that electrical contacting is simplified. The connector/terminals are preferably electrically routed to the power supply, so that the power supply is powered by means of the main power line. In this case, for example, the power supply transforms and/or at least stabilizes the electrical voltage, provided by the main power line, to a suitable value, which is applied in particular to a secondary side of the power supply. In summary, the power supply unit expediently comprises a primary side connected to the main power line in the mounted state. On the primary side of the power supply, for example, a single-phase or multi-phase alternating voltage or a direct voltage is provided as input voltage via one or also multiple connecting terminal arrangements. A ground or protective conductor is additionally connected in particular via at least one terminal.

The housing has a fastening apparatus for direct placement on the mounting rail. For example, the housing is simply placed on the mounting rail, which simplifies mounting. Alternatively, for example, clamping to the mounting rail can be carried out for this purpose. For this purpose, the fastening apparatus has, for example, a corresponding fastening element, for example, a screw, which engages the mounting rail frictionally by means of actuation. Alternatively, the fastening element is a snap arm or the like that engages in a corresponding recess of the mounting rail. Preferably, the fastening apparatus comprises at least one U-shaped section by means of which at least part of the mounting rail is gripped, which also expediently enables heat to be dissipated from the housing to the mounting rail. The gripping is stabilized by means of any fastening element, such as the screw or the snap arm, so that detachment of the housing from the mounting rail without first actuating the fastening element is not possible. The position of the housing and therefore also of the power supply unit is thus stabilized and consequently safety is increased.

A contact region is introduced in the housing, which has a first contact and a second contact. The first contact is in electrical contact with the first connection of the power supply. The second contact is in electrical contact with the second connection of the power supply, so that an electrical potential difference prevails between the two contacts during operation. For example, another component is arranged between at least one of the contacts and the respective connection. Particularly preferably, however, direct electrical contacting occurs, so that the electrical voltage applied to the contacts corresponds to the electrical voltage applied to the connections. Preferably, the contacts are made of an electrically conductive material, preferably a metal, and are provided, for example, by means of sheet metal tabs or the like.

The switch assembly further has a switchgear, for example, provided and designed to be in electrical contact with the possible secondary circuit. The switchgear comprises an additional housing having an additional fastening apparatus for direct placement on the mounting rail. For example, the additional fastening apparatus is structurally identical to the fastening apparatus or differs therefrom. The switchgear is connected, in particular fastened, to the mounting rail in the mounted state by means of the additional fastening apparatus and is thus held there. The additional housing preferably has a terminal and/or a corresponding connector to which the possible secondary circuit can be connected.

In addition, the switchgear has a lever which is pivotably mounted about a pivot axis on the additional housing. In particular, the lever is mounted on the housing at one of its ends so that it can be folded away from the housing. Expediently, the course of the lever is substantially perpendicular to the mounting rail, and the pivot axis is preferably parallel to the mounting rail, which simplifies operation. The lever is suitable, in particular provided and designed, to be operated manually. The lever has a suitable formation, for example, a corresponding projection, for this purpose.

The lever comprises a first counterpart contact and a second counterpart contact, which are expediently connected to a carrier of the lever. The carrier is suitably made of a plastic or the like and is preferably electrically non-conductive. The carrier is preferably attached to the housing. Thus, it is possible to fabricate the carrier with a relatively high level of robustness, wherein the counterpart contacts are made of an electrically conductive or conductible material, preferably of sheet metal. Thus, manufacture is simplified.

By pivoting the lever, it is possible to bring the first counterpart contact into electrical contact with the first contact and the second counterpart contact into electrical contact with the second contact. In this state, preferably the first counterpart contact directly abuts the first contact mechanically and/or the second counterpart contact directly abuts the second contact mechanically, preferably mechanically directly in each case. Thus, by means of the lever, it is possible to assume a position in which there is an electrical contact. By pivoting the lever from this position, the contacts and the counterpart contacts are preferably separated from one another and, in particular, are no longer in direct mechanical contact with one another. Suitably, it is possible here to create a relatively large distance between the counterpart contacts and the respective contacts, for example, of more than 5 mm or 1 cm. Thus, the lever has at least two different positions, wherein in one position there is electrical contacting and in the other position there is electrical insulation of the contacts from the counterpart contacts.

Thus, in the case of the switch assembly, the electrical contact between the switchgear and the power supply unit is made by means of the lever, which is located at a predefined position with respect to the additional housing. Thus, it is possible to create the electrical contact within a relatively short period of time, namely, by pivoting the lever, which is operated manually in particular. Consequently, no additional material and also no additional tools are required. As a result, mounting of the switch assembly and also removal are facilitated. In addition, interchangeability is also increased if, for example, the power supply unit and/or the switchgear are to be replaced, for example, due to a defect or in order to make a power adjustment. For this purpose, it is only necessary to pivot the lever accordingly and to remove the respective component of the switch assembly and replace it with a new one. There is also failure safety in the production of the electrical contacts, because faulty electrical contacting of the contacts with the respective counterpart contacts is prevented. The space requirement is also reduced because no cables or the like are needed.

The power supply unit and/or the switchgear are expediently designed as a rail-mounted device and thus as a device that can be mounted side-by-side. Consequently, mounting in an existing switchgear cabinet is also made possible. Expediently, the switchgear has an additional contact region that is designed substantially similar to the contact region. Thus, it is possible to connect in the same way to the switchgear additional switchgears, which are structurally identical or which at least also have the lever, or other control units or automation devices, such as buffer modules, controllers, communication modules, relays, safety relays, or wiring modules, which also have such a lever. For example, the switchgears always have the same function or different functions. Thus, it is possible to provide a switch assembly by means of which, for example, a plurality of secondary circuits can be supplied and/or by means of which a plurality of different functions can be accomplished, wherein the functions can be adapted to the particular application in each case.

For example, the counterpart contacts are designed as male or female connectors, whereas the contacts are designed with the corresponding connector. Particularly preferably, both are substantially merely plate-like, at least in the area where they mechanically abut each other when the lever is in the corresponding position. Preferably, the counterpart contacts are made of a spring sheet and are bent in a U-shape, for example, wherein, in the contacted state, one of the legs abuts against the respective corresponding contact. Preferably, the contact here is located between the two legs and is arranged parallel to them. In particular, a spring force acts on the leg so that it is pressed against the respective contact. Thus, electrical contacting is improved.

For example, the contact region is located on a top side of the device, whereas a side perpendicular to it faces the switchgear. Preferably, the fastening apparatus is located on the housing side opposite the contact region. It is thus possible to visually inspect the contact region. Particularly preferably, however, the contact region is located on the housing side facing the switchgear. Thus, a required distance for electrical contacting is reduced. It is also prevented in this way that additional components are in electrical contact with the contacts and/or the counterpart contacts, which is why a short circuit is prevented. Particularly preferably, the housing and the additional housing partially abut one another, so that the contact region is also at least partially delimited by the additional housing. Consequently, the contacts and counterpart contacts are protected and safety is increased.

For example, the counterpart contacts are electrically connected directly to additional components of the switchgear. In particular, a corresponding line, such as a cable, or a trace of a printed circuit board is attached, for example, soldered, to the respective counterpart contact for this purpose. Alternatively, the counterpart contact is formed at least in part by a bus bar that projects into the additional housing of the switchgear. Particularly preferably, however, an additional contact region, which has an additional first contact and an additional second contact, is introduced into the additional housing. For example, the additional contacts are substantially structurally identical to the contacts. By pivoting the lever, the first counterpart contact can be brought into electrical contact with the additional first contact and the second counterpart contact into electrical contact with the additional second contact. If the first counterpart contact is in electrical contact with the first contact, expediently the first counterpart contact is also contacted with the additional first contact. Thus, electrical contacting occurs between the first contact and the additional first contact by means of the first counterpart contact. In this case as well, the second contact is preferably in electrical contact with the additional second contact by means of the second counterpart contact. Then, if the counterpart contacts are separated from the contacts, they are expediently separated from the additional contacts as well. Thus, in this state, there is electrical insulation of the contacts from the additional contacts. The counterpart contacts are preferably made U-shaped, in particular clip-like. In the electrically contacted state, the contacts as well as the additional contacts are located between the respectively associated legs of the respectively associated U-shaped counterpart contact. These are preferably designed as resilient, so that they are mechanically pressed against the contacts and the counterpart contacts. Suitably, an additional component of the contact region or the additional contact region is present between the contacts and the additional contacts, so that they are electrically insulated from each other when the lever is pivoted accordingly. Thus, an electrical connection between the contacts and the additional contacts is only present in a corresponding position of the lever, which increases safety. Preferably, the additional contact region is located on the side facing the switchgear, so that the lever can be designed to be relatively space-saving. This also simplifies operation and reduces the material requirement.

The switchgear can have a switching element or a number of switching elements that are in electrical contact with at least one of the additional contacts, for example, by means of an electrical series circuit or an electrical parallel circuit. The switching element/switching elements are expediently arranged in the additional housing, which increases safety. For example, the switching elements can be actuated mechanically and/or by means of a corresponding control. Suitably, one of the switching elements, preferably all of them or at least their interconnection, is routed to the possible secondary circuit, so that the possible secondary circuit can be interrupted by actuating the switching element/switching elements. Control is thus simplified.

Suitably, the switchgear comprises a sensor as a function of which at least one of the switching elements is actuated. In particular, the electric current conducted by means of the switchgear and/or the electric voltage applied to it are monitored by means of the sensor. Consequently, the switchgear performs the function of a circuit breaker, for example, of a miniature circuit breaker, which is why safety is increased.

At least one of the switching elements can be designed as a mechanical switch, for example, and is a relay or contactor, for example. Alternatively, the switching element is a semiconductor switch, in particular a power semiconductor switch, such as a MOSFET. If there are multiple switching elements, one of them is expediently a mechanical switch and another one is a semiconductor switch.

A control unit can be arranged in the housing. The control unit is used, for example, to control the power supply. Alternatively or in combination with this, the control unit carries out certain switch assembly functions, which in particular are used for the operation of the complete switch assembly, therefore, also the operation of the switchgear or additional components of the switch assembly. The control unit is formed by means of or comprises an application-specific circuit (ASIC), for example. Alternatively or in combination therewith, the control unit has a microprocessor for this purpose, which is expediently designed to be programmable.

The control unit may be signal-connected to a third contact of the contact region. In other words, the contact region has the third contact, which is constructed similar to the first and/or second contact, for example. In this case, the lever preferably comprises a corresponding third counterpart contact, which is, for example, constructed similar to the first and/or second counterpart contact. By pivoting the lever, the third counterpart contact is signal-connected to the third contact, preferably electrically and/or mechanically. Thus, it is possible to exchange signals, preferably electrical, via the third contact and the third counterpart contact. Thus, the third contact or third counterpart contact corresponds to a signal contact in each case.

The contact region can have a fourth contact and the lever has a corresponding fourth counterpart contact, wherein the fourth contact is signal-connected to the control unit. Thus, an exchange of signals, therefore, of data, is improved. In particular, the exchanged signals/data meet a bus standard so that a bus system is formed. The control unit is hereby expediently configured as a master of the bus system. Suitably, the switchgear has an additional control unit by means of which, for example, the possible switching element and/or the possible switching elements are controlled. The additional control unit is expediently configured as a slave of the bus system. If there are multiple switchgears of this type, they are all expediently configured as slaves. This enables the switchgears to be replaced without the bus system having to be reconfigured relatively extensively.

For example, the contact region can have only the contacts. Particularly preferably, however, the contact region comprises a base body made of an electrically insulating material, for example, a plastic. The contacts are expediently stabilized by means of the base body. Particularly preferably, the contact region comprises a web that is, for example, integral with the base body or a component of the base body. The web is expediently made of an electrically insulating material. When each contact is contacted with the corresponding, therefore, associated, counterpart contact, and these preferably abut one another mechanically, the web is preferably gripped by the lever. The gripping is hereby released by pivoting the lever. Suitably, the first and second counterpart contacts and/or any additional counterpart contacts grip around the web in this case. Expediently, the lever, in particular the counterpart contacts, is at least partially in direct mechanical contact with the web. As a result, the contact region and thus the housing are held against the switchgear when the lever is in the specific position. Mechanical stability is thus increased and unintentional detachment of the contacts from their respective associated counterpart contacts is prevented. It is also ensured in this way that the contacts are actually in electrical contact with the counterpart contacts during mounting. This only occurs when the web is gripped. In the case this is not possible, for example, due to an undesirable positioning of the two housings in relation to each other, the pivoting of the lever is prevented by means of the web, so that it is apparent to the person carrying out the mounting that the two housings are not suitably positioned.

For example, each contact may be provided by means of a corresponding connector or the like. Particularly preferably, however, the contact is formed by means of a sheet metal strip. Thus, manufacturing costs are reduced. Preferably, each contact here abuts the web. Thus, the contacts are stabilized by means of the web, which prevents damage. It is also possible to use relatively thin-walled sheet metal. Suitably, the contacting of the contacts is made with the counterpart contacts on the side opposite the web, so that a relatively large area is available for contacting. Expediently, the sheet metal strips are created as stamped/bent parts, which further reduces manufacturing costs. Suitably, the sheet metal strip is substantially L-shaped, with one leg abutting the web. The leg arranged perpendicular hereto serves in particular for contacting the respective connection of the power supply. In particular, this leg sits on an edge of the possible base body, so that the contacts are stabilized and are not displaced when the lever is pivoted. Robustness is thus increased.

For example, the contacts can be arranged adjacent to one another, wherein there is a distance between them so that an electrical short circuit is avoided. Particularly preferably, however, each contact is assigned a chamber within which they are each at least partially inserted. Therefore, another component, in particular of the base body, is arranged between the individual contacts. Thus, there is a further stabilization of the contacts, as well as insulation between them. It is also prevented that the contacts are damaged and bent when the lever is moved incorrectly, so that they come into direct mechanical contact with one another.

The web can have a number of retaining lugs corresponding to the number of contacts. For example, the number is equal to the number of contacts, or each contact is associated with multiple such retaining lugs, preferably two. Each of the contacts is at least partially gripped by the retaining lugs. Here, at least one retaining lug, preferably two of the retaining lugs, is associated with each contact. Further stabilization of the contacts is achieved by means of the retaining lugs, which increases robustness.

For example, the contact region can be screwed to the housing or additional components of the switchgear. Particularly preferably, however, the contact region, in particular the possibly present base body, is latched to the housing. For example, the contact region, suitably the base body, comprises corresponding latching hooks which, in the mounted state, are latched to corresponding hooks or lugs of the housing. Thus, if the latching hooks are damaged, it is only necessary to replace the contact region but not the entire housing. The contacts expediently comprise appropriate connection points by means of which there is an electrical contacting of corresponding additional components of the power supply, in particular of the connections, of any trace, or the like. Preferably, the contacting occurs by insertion of the contacts into corresponding receptacles. For example, the contacts in this region are designed as blade contacts that engage with corresponding tuning fork contacts in the interior of the housing. Mounting is thus simplified. If the contact region is not needed, it is possible to remove it from the housing and to replace it with an appropriate cover. Thus, there are no open contacts and penetration of foreign particles into the housing is prevented. Thus, it is possible to use the power supply unit for different applications. It is also possible to adapt the power supply unit to the particular application only at the end of production by using the cover or the contact region.

The power supply unit can be used to connect to a switchgear and has a housing. The housing comprises a fastening apparatus for direct placement on a mounting rail. The fastening apparatus is suitable, in particular provided and designed for this purpose. A power supply is arranged in the housing and comprises a first and second connection. Further, the power supply unit has a contact region which is introduced in the housing and has a first contact and a second contact. The first contact is in electrical contact with the first connection and the second contact is in electrical contact with the second connection. In this case, the contact region is formed such that by pivoting a lever of a switchgear, the first contact can be brought into electrical contact with a first counterpart contact of the lever and the second contact can be brought into electrical contact with a second counterpart contact of the lever, wherein the lever is pivotably mounted on an additional housing of the switchgear. In particular, the power supply unit is designed as a rail-mounted device and thus as a device that can be mounted side-by-side. Thus, the power supply unit is suitable, in particular provided and designed, for connection to the switchgear.

If a component is referred to as the first, second, third, . . . component, this refers in particular only to a specific component. In particular, this does not mean that a certain number of such components is present.

The refinements and advantages explained in connection with the switch assembly are analogously also to be applied to the power supply unit and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically simplified a circuit diagram of a switch assembly having a power supply unit and a plurality of switchgears;

FIG. 2 shows the switch assembly perspectively;

FIG. 3 shows the switchgears perspectively;

FIG. 4 shows perspectively the power supply unit having a contact region; and

FIGS. 5-7 show the contact region in different views.

### DETAILED DESCRIPTION

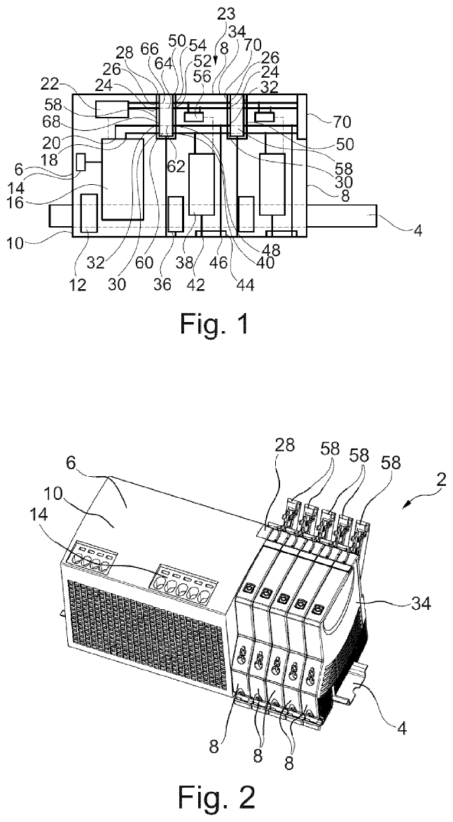

FIG. 1 shows a schematic circuit diagram of a switch assembly 2 attached to a mounting rail 4. Mounting rail 4 is a top-hat rail and is arranged in a switchgear cabinet not shown in more detail. Switch assembly 2 is used for the supplying, overcurrent protection, and power distribution and is a component of an industrial installation not shown in more detail. Switch assembly 2 has a power supply unit 6 and two switchgears 8, which are structurally identical to one another. Power supply unit 6 and switchgears 8 are attached to mounting rail 4 and are designed as devices mountable side-by-side.

Power supply unit 6 has a housing 10 at least partially made of a metal, in particular a sheet metal, with a fastening apparatus 12. Fastening apparatus 12 is placed directly on mounting rail 4. Fastening apparatus 12 has a corresponding section that is adapted to the external dimensions of mounting rail 4, so that fastening apparatus 12 and therefore housing 10 as well can be hooked into mounting rail 4. A connector 14, which is provided and designed to be connected to a main power line, is inserted into housing 10. Connector 14 is electrically connected to a power supply 16, so that power supply 16 is powered by means of connector 14 during operation. Power supply 16 is a switched-mode power supply and has a first connection 18 and a second connection 20 between which an electrical voltage is applied during operation. Here, power supply 16 is an adjustable switched-mode power supply, which is why the electrical voltage applied to connections 18, 20 can be adjusted. The electrical voltage applied to the two connections 18, 20 is a direct voltage, which is 12 V or 24 V.

The adjustment is made by means of a control unit 22 also located in housing 10. Power supply 16 is also monitored for its functionality by means of control unit 22. Control unit 22 is further configured as a master of a bus system 23 and is signal-connected to a third and fourth contact 24, 26 of a contact region 28. Contact region 28 further has a first contact 30 and a second contact 32, wherein first contact 30 is in electrical contact with first connection 18 and second contact 32 is in electrical contact with second connection 20. Thus, during operation, the same electrical voltage is present between first contact 30 and second contact 32 as is present between first connection 18 and second connection 20.

Directly adjacent to housing 10 of power supply unit 6 is an additional housing 34 of one of the structurally similar switchgears 8, so that additional housing 34 abuts housing 10. This additional housing 34 also has an additional fastening apparatus 36, which is placed directly on mounting rail 4. Thus, additional housing 34 is stabilized with respect to mounting rail 4 by means of additional fastening apparatus 36.

Arranged within additional housing 34 is a switching element 38, which is electrically connected between an additional first contact 40 and an additional first connection 42 of an additional connector 44. Switching element 38 is designed as a mechanical switch such as a contactor, a semiconductor switch such as a MOSFET, or a combination thereof. Additional connector 44 has an additional second connection 46, which is electrically routed directly to an additional second contact 48. In the mounted state, a secondary circuit, which is not shown in more detail, is connected to additional connector 44 and is supplied and monitored by means of said switchgear 8.

Additional first contact 40 and additional second contact 48 are components of an additional contact region 50, which moreover has an additional third contact 52 and an additional fourth contact 54. Additional third contact and additional fourth contact 54 are signal-connected to an additional control unit 56, by means of which switching element 38 is actuated. Here, additional control unit 56 is configured as a slave of bus system 23. Additional control unit 56 is also signal-connected to sensors, not shown in more detail, by means of which the electrical voltage applied to additional connector 44 and the electrical current carried thereby are monitored. If this value or the change in the respective variables exceeds a certain assigned limit value, switching element 38 is actuated so that an electric current flow via additional connector 44 is interrupted.

Contact region 28 as well as additional contact region 50 are aligned with one another and inserted into the abutting sides of housing 6 and additional housing 34. In other words, contact region 28 is located on the side of housing 10 facing switchgear 8. In addition, contact region 28 and additional contact region 50 are mechanically as well as electrically connected to one another by means of a lever 58, which is pivotably mounted on additional housing 34.

Lever 58 has a first counterpart contact 60, a second counterpart contact 62, a third counterpart contact 64, and a fourth counterpart contact 66 made of an electrically conductive sheet and attached to a support 68 made of a plastic and pivotably mounted on additional housing 34. First contact 30 is electrically connected to additional first contact 40 by means of first counterpart contact 60. Second contact 32 is electrically connected to additional second contact 48 by means of second counterpart contact 62. Third contact 24 is signal-connected and also electrically connected to additional third contact 52 by means of third counterpart contact 64. Fourth contact 26 is electrically connected and therefore also signal-connected to additional fourth contact 54 by means of fourth counterpart contact 66. For this purpose, counterpart contacts 60, 62, 64, 66 are in direct mechanical contact with the corresponding contacts 24, 26, 30, 32 and additional contacts 40, 48, 52, 54. In summary, contact region 28 and additional contact region 54 are bridged by means of lever 58. By pivoting carrier 68, counterpart contacts 60, 62, 64, 66 are released from the respective associated contacts 24, 26, 30, 32 and additional contacts 40, 48, 52, 54, and thus the electrical connection between contacts 24, 26, 30, 32 with the respective additional contacts 40, 48, 52, 54 is interrupted. In summary, by pivoting lever 58, first counterpart contact 60 can be brought into electrical contact with first contact 30 and second counterpart contact 62 can be brought into electrical contact with second contact 32, as well as third counterpart contact 64 can be brought into electrical contact with third contact 24, and fourth counterpart contact 66 can be brought into electrical contact with fourth contact 26, wherein the contacting is broken by a corresponding counter-movement.

On the side opposite additional contact region 50, an additional contact region 70 is introduced into additional housing 34, which region is constructed in the same way as contact region 28 and which thus also has the first, second, third, and fourth contacts 30, 32, 24, 26. Contacts 24, 26, 30, 32 of additional contact region 70 are hereby electrically routed directly to the corresponding additional contacts 40, 48, 52, 54 of additional contact region 50. Additional contact region 50 is connected to additional contact region 70 of the remaining switchgear 8 by means of lever 58 of the remaining switchgear 8. This switchgear 8 is used here for the protection of an additional secondary circuit, wherein this switchgear 8 is also supplied with current by means of power supply unit 6.

FIG. 2 shows switch assembly 2 perspectively, wherein in this variant there are a total of five switchgears 8 which are structurally identical to one another. Also, levers 58 are pivoted away from additional housings 34, so that switchgears 8 as well as power supply unit 6 are disconnected from one another electrically and in terms of signaling.

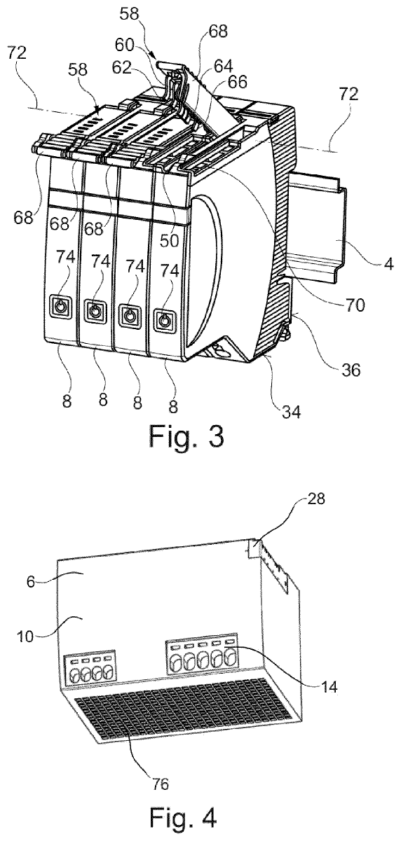

FIG. 3 shows perspectively a part of switchgears 8, each of which has a lever 58 pivotably mounted to housing 34 about a pivot axis 72. Here, when counterpart contacts 60, 62, 64, 66 are contacted at the corresponding contacts 24, 26, 30, 32, carrier 68 abuts the particular additional housing 34 and has an overhang so that manual operation is made possible. Counterpart contacts 60, 62, 64, 66 are made of a spring plate and formed by means of U-shaped clips so that they are elastically bent when contacting contacts 24, 26, 30, 32 as well as additional contacts 40, 48, 52, 54, which improves electrical contacting. Further, an operating unit 74 in the form of a push button is introduced into each additional housing 34. Operating unit 74 is monitored by means of additional control unit 56. When operating unit 74 is manually actuated, switching element 38 is placed in the electrically conductive or electrically non-conductive state.

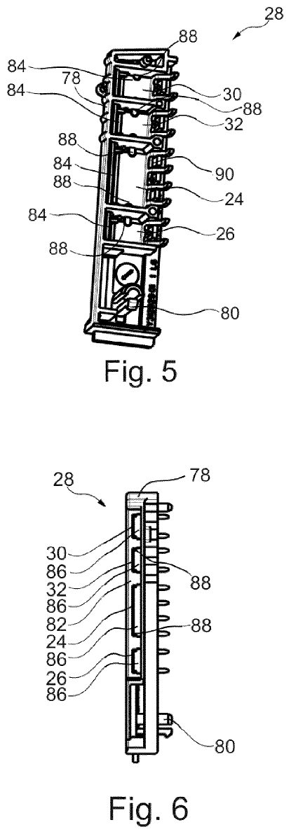

FIG. 4 shows power supply unit 6 perspectively. Housing 10 is made substantially cuboid in shape, and one side is formed by means of a grille 76 so that air exchange is enabled. One part of the cuboid is cut out to provide contact region 28, which is shown perspectively in a view from within housing 10 in FIG. 5. Contact region 28 is shown in a top view in FIG. 6. Contact region 28 has a base body 78 which is made of a plastic. Base body 78 has a latching hook 80 which, in the mounted state, latches with the corresponding counterparts of housing 10. Thus, replacement of contact region 28 is facilitated. It is also possible to design power supply unit 6 for different applications, wherein, if power supply unit 6 is not to become a component of such a switch assembly 2, a corresponding cover without contacts is used instead of contact region 28.

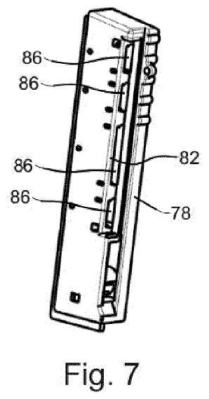

As also shown in FIG. 7 in a perspective top view from outside housing 10, base body 78 has a web 82 in which four chambers 84 are provided. Each of chambers 84 opens into a slot 86 through which counterpart contacts 60, 62, 64, 66 are inserted for electrical contacting with respective contacts 24, 26, 30, 32. The first, second, third, and fourth contacts 24, 26, 30, 32 are arranged within the chambers; these contacts are formed as sheet metal strips which at least partially abut web 82 and are held in place by means of two retaining lugs 88 in each case. Thus, each contact 24, 26, 30, 32 is partially gripped by at least two retaining lugs 88 of web 82 in each case. Consequently, contacts 24, 26, 30, 32 are stabilized by means of web 82, and counterpart contacts 60, 62, 64, 66 abut against them in the contacted state over a relatively large area with one of the legs of the clip, parallel to one another. Thus, web 82 is gripped by counterpart contacts 60, 62, 64, 66 and therefore also by lever 58, so that additional housing 34 is held on housing 10. Thus, switchgear 8 is stabilized relative to power supply unit 6.

Contacts 24, 26, 30, 32 also abut web 82. Contacts 24, 26, 30, 32 are formed L-shaped, wherein the end that is opposite slot 86 is placed on an edge 90 of base body 78, so that the spacing apart of contacts 24, 26, 30, 32 from the respective slot 86 is prevented. These legs have a pin-like configuration at the ends and are electrically contacted with connections 18, 20 and control unit 22 when base body 78 is latched to housing 10.

In summary, a simplified mounting/removal takes place by means of switch assembly 2, wherein no additional parts are required. Expandability and interchangeability are also improved and the space requirement is reduced. Switchgears 8 are a rail-mounted device and perform the functions required for the respective application. For example, these are the function of a circuit breaker, a relay, a protective element, and/or a potential distributor. Power supply unit 6 has contact region 28, wherein a corresponding through-contacting of power supply 16, arranged in housing 10, as well as of additional components arranged there, such as control unit 22, takes place by means of lever 58 of switchgear 8 adjacent thereto. In the open state of lever 56, all connections, therefore, the electrical contacting, are released and the configuration of switch assembly 2 can be changed by arranging the individual components, therefore, switchgears 8 as well as power supply unit 6, accordingly on mounting rail 4. All connections are made in the closed state of lever 58, wherein a corresponding bridging occurs by means of counterpart contacts 60, 62, 64, 66. The individual components, therefore, switchgears 8 and power supply unit 6, are also mechanically fixed hereby. Contacts 24, 26, 30, 32, additional contacts 40, 48, 52, 54, as well as counterpart contacts 60, 62, 64, 66 are electrically insulated from the environment of switch assembly 2 by means of carrier 68, which increases safety.

The invention is not limited to the exemplary embodiment described above. Rather, other variants of the invention can also be derived herefrom by the skilled artisan, without going beyond the subject of the invention. Particularly, further all individual features described in relation to the exemplary embodiment can also be combined with one another in a different manner, without going beyond the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switch assembly for mounting on a mounting rail, the switch assembly comprising:
a power supply unit having a housing and a power supply arranged therein, which comprises a first connection and a second connection;
a switchgear;
a contact region having a first contact, which is in electrical contact with the first connection; and
a second contact, which is in electrical contact with the second connection is introduced into the housing,
wherein the housing has a fastening apparatus for direct placement on the mounting rail,
wherein the switchgear comprises an additional housing having an additional fastening apparatus for direct placement on the mounting rail,
wherein the switchgear has a lever which is pivotably mounted on the additional housing and which has a first counterpart contact and a second counterpart contact, and
wherein by pivoting the lever, the first counterpart contact is adapted to be brought into electrical contact with the first contact and the second counterpart contact is adapted to be brought into electrical contact with the second contact.

2. The switch assembly according to claim 1, wherein the contact region is located on the side of the housing facing the switchgear.

3. The switch assembly according to claim 1, wherein an additional contact region having an additional first contact and having an additional second contact is introduced into the additional housing, wherein the first counterpart contact is adapted to be brought into electrical contact with the additional first contact and the second counterpart contact is adapted to be brought into electrical contact with the additional second contact by means of pivoting the lever.

4. The switch assembly according to claim 1, wherein a control unit is arranged in the housing and is signal-connected to a third contact of the contact region, and wherein the lever has a corresponding third counterpart contact.

5. The switch assembly according to claim 1, wherein the contact region has a web which is gripped by the lever when each contact is contacted by the respective associated counterpart contact.

6. The switch assembly according to claim 5, wherein each contact is formed by a sheet metal strip which abuts against the web.

7. The switch assembly according to claim 6, wherein each contact is at least partially gripped by a respective retaining lug of the web.

8. The switch assembly according to claim 1, wherein the contact region is latched to the housing.

9. A power supply unit according to claim 1.
